(19) United States
(12) Patent Application Publication
(10) Pub. No.: US 2025/0271985 A1
(43) Pub. Date: Aug. 28, 2025

(54) DISPLAY DEVICE FOR ONBOARDING PLURALITY OF VOICE ASSISTANTS USING PLURALITY OF QR CODES, ELECTRONIC DEVICE, AND METHOD FOR CONTROLLING DISPLAY DEVICE AND ELECTRONIC DEVICE

(71) Applicant: Samsung Electronics Co., Ltd., Suwon-si (KR)

(72) Inventors: Soyoung JUNG, Suwon-si (KR); Kihyoung SON, Suwon-si (KR); Sooyeon HAN, Suwon-si (KR); Youngah LEE, Suwon-si (KR)

(21) Appl. No.: 19/209,312

(22) Filed: May 15, 2025

Related U.S. Application Data
(63) Continuation of application No. PCT/KR2023/016166, filed on Oct. 18, 2023.

(30) Foreign Application Priority Data
Nov. 15, 2022 (KR) 10-2022-0152911

(51) Int. Cl. G06F 3/0484; G06F 3/16; G06K 7/10; G06K 7/14

(52) U.S. Cl. CPC G06F 3/0484; G06F 3/167; G06K 7/10722; G06K 7/1417

(57) ABSTRACT

A display device may include a display, and one or more processors which receive a user command for onboarding a plurality of voice assistants to the display device, and controls the display to display a screen including a plurality of QR codes corresponding to the plurality of voice assistants based on order information of the plurality of voice assistants, wherein each of the plurality of QR codes includes a URL of a server at which login of user accounts corresponding to the voice assistants are performed.

### CROSS-REFERENCE TO RELATED APPLICATIONS

This application is a continuation application of International Application No. PCT/KR2023/016166 designating the United States, filed on Oct. 18, 2023, in the Korean Intellectual Property Receiving Office and claiming priority to Korean Patent Application No. 10-2022-0152911, filed on Nov. 15, 2022, the disclosures of which are all hereby incorporated by reference herein in their entireties.

### BACKGROUND

### Technical Field

Certain example embodiments may relate to a display device, an electronic device, and/or a method for controlling the same and for example, a display device for onboarding a plurality of voice assistants using a plurality of quick response (QR) codes, an electronic device, and/or a method for controlling the same.

### Background Art

Thanks to the development of electronic technologies, a display device such as a TV may provide various services.

In particular, the display device may provide a response to a voice command of

a user via a voice assistant and control other devices.

### SUMMARY

According to an example embodiment, the display device may include a display and one or more processors. Each processor may comprise processing circuitry. The one or more processors may be individually and/or collectively configured to receive a user command for onboarding a plurality of voice assistants to the display device. The one or more processors may be individually and/or collectively configured to control the display to display a screen including a plurality of QR codes corresponding to the plurality of voice assistants based on order information of the plurality of voice assistants. Each of the plurality of QR codes may include a URL of a server at which login of a user account corresponding to a voice assistant is performed.

Otherwise, according to an example embodiment, the display device may include a communication interface comprising interface circuitry, wherein the one or more processors, based on capture completion information being received from an electronic device obtaining an image including the plurality of QR codes displayed on the display through the communication interface, may be individually and/or collectively configured to deactivate the other QR codes, excluding a first QR code corresponding to a first voice assistant of which an onboarding order is the fastest among the plurality of QR codes displayed on the display based on the order information, and based on login being performed based on the user account corresponding to the first voice assistant, display a completion User Interface (UI) on the first QR code and activate a second QR code corresponding to a second voice assistant having an onboarding order next to the first voice assistant among the other deactivated QR codes based on the order information.

Further, the one or more processors may be individually and/or collectively configured to display a plurality of order UIs on the plurality of QR codes based on the order information.

The one or more processors, based on login being performed based on the user account corresponding to the first voice assistant, may change a first type of order UI displayed on a preset area within the second QR code to a second type of order UI, wherein the first type of order UI may include a number indicating an order in which the second voice assistant corresponding to the second QR code is onboarded, and wherein the second type of order UI may include a character indicating the order in which the second voice assistant corresponding to the second QR code is onboarded.

According to an example embodiment, an electronic device may include a display, a camera, and one or more processors comprising processing circuitry. The one or more processors may be individually and/or collectively configured to obtain an image capturing a plurality of QR codes displayed on a display device by using the camera. The one or more processors may be individually and/or collectively configured to display the obtained image on the display. The one or more processors may be individually and/or collectively configured to control the display to display a UI corresponding to a QR code and a URL obtained from the QR code based on order information of a plurality of voice assistants corresponding to the plurality of QR codes. Each of a plurality of URLs is or includes a URL of a server at which login of a user account corresponding to a voice assistant is performed.

The one or more processors may be individually and/or collectively configured to display a plurality of order UIs indicating an order in which the plurality of voice assistants are onboarded to the display device on the plurality of QR codes based on the order information, display a URL obtained from a first QR code corresponding to a first voice assistant of which an onboarding order is the fastest among the plurality of voice assistants based on the order information, and based on login being performed based on the user account corresponding to the first voice assistant, display a URL obtained from a second QR code corresponding to a second voice assistant having an onboarding order next to the first voice assistant based on the order information.

The one or more processors may be individually and/or collectively configured to focus on and display the first QR code corresponding to the first voice assistant based on the order information, and based on login being performed based on the user account corresponding to the first voice assistant, focus on and display the second QR code corresponding to the second voice assistant based on the order information.

The one or more processors may be individually and/or collectively configured to display a plurality of URLs and display the plurality of order UIs indicating the order in which the plurality of voice assistants are onboarded to the display device on the plurality of URLs based on the order information.

According to an example embodiment, a method of controlling a display device may include receiving a user command for onboarding a plurality of voice assistants to the display device, and displaying a screen including a plurality of QR codes corresponding to the plurality of voice assistants based on order information of the plurality of voice assistants, wherein each of the plurality of QR codes may include a URL of a server at which login of a user account corresponding to a voice assistant is performed.

According to an example embodiment, a method of controlling an electronic device including a camera may include obtaining an image capturing a plurality of QR codes displayed on a display device by using the camera, displaying the obtained image, and displaying a UI corresponding to a QR code and a URL obtained from the QR code based on order information of a plurality of voice assistants corresponding to the plurality of QR codes, wherein each of a plurality of URLs is a URL of a server at which login of a user account corresponding to a voice assistant is performed.

According to an example embodiment, a non-transitory computer readable medium storing computer instructions, when executed by one or more processors of a display device, may cause the display device to receive a user command for onboarding a plurality of voice assistants to the display device, and display a screen including a plurality of QR codes corresponding to the plurality of voice assistants based on order information of the plurality of voice assistants, wherein each of the plurality of QR codes may include a URL of a server at which login of a user account corresponding to a voice assistant is performed.

According to an example embodiment, a non-transitory computer readable medium storing computer instructions, when executed by one or more processors of an electronic device including a camera, may cause the electronic device to obtain an image capturing a plurality of QR codes displayed on a display device by using the camera, display the obtained image, and display a UI corresponding to a QR code and a URL obtained from the QR code based on order information of a plurality of voice assistants corresponding to the plurality of QR codes, wherein each of a plurality of URLs is a URL of a server at which login of a user account corresponding to a voice assistant is performed.

### BRIEF DESCRIPTION OF DRAWINGS

FIG. 1 is a view illustrating a system according to an example embodiment;

FIGS. 2A, 2B, and 2C are block diagrams illustrating a configuration of a display device according to an example embodiment;

FIGS. 3A, 3B, and 3C are block diagrams illustrating a configuration of an electronic device according to an example embodiment;

FIG. 4 is a flow chart illustrating a method of onboarding a plurality of voice assistants to a display device by using an electronic device according to an example embodiment;

FIG. 5 is a view illustrating an example of a UI screen displayed on a display device according to an example embodiment;

FIGS. 6, 7, 8, 9, 10, 11, 12, 13, 14, 15A and 15B are views illustrating a method of onboarding a plurality of voice assistants to a display device by using an electronic device according to an example embodiment(s);

FIG. 16 is a flow chart illustrating a method of controlling a display device according to an example embodiment; and

FIG. 17 is a flow chart illustrating a method of controlling an electronic device including a camera according to an example embodiment.

### DETAILED DESCRIPTION

The term used in the disclosure is briefly described and then the disclosure is specifically described.

The terms used in embodiments of the disclosure are selected as general terms which are currently widely used as much as possible in consideration of functions in the disclosure but may be varied depending on intention of those skilled in the art, a precedent, appearance of new technologies, or the like. Also, there is a term which is arbitrarily selected by the applicant in a certain case and in this case, its meaning is specifically described in the relevant description part of the disclosure. Therefore, the term used in the disclosure should be defined based on the meaning of the term and the entire content throughout the disclosure rather than the simple name of the term.

In the disclosure, the expression such as “have,” “may have,” “include”, or “may include” denotes the existence of such a characteristic (e.g. a numerical value, a function, an operation, or a component such as a part), and the expression does not exclude the existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expression “1st”, “2nd”, “first”, “second”, or the like used in the disclosure may be used to describe various elements regardless of any order and/or degree of importance, wherein the expression is used only to distinguish one element from another element and is not intended to limit the elements.

Meanwhile, the description that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through the other element (e.g. a third element).

The expression “configured to” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean “specifically designed to” in terms of hardware.

Under some circumstances, the expression “a device configured to” may mean that the device “is capable of” performing an operation together with another device or component. For example, the phrase “a processor configured to (set to) perform A, B, and C” may mean a dedicated processor for performing the corresponding operations (e.g. an embedded processor), or a generic-purpose processor that may perform the corresponding operations by executing one or more software programs stored in a memory device (e.g. a CPU or an application processor).

A singular expression includes a plural expression, unless obviously differently defined in the context. In the application, the term such as “include” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In embodiments of the disclosure, a “module” or “part” may perform at least one function or operation and may be implemented as hardware or software, or as a combination of hardware and software. Also, a plurality of “modules” or “parts” may be integrated into at least one module and implemented as at least one processor (not shown), excluding a “module” or a “part” that needs to be implemented as specific hardware. Thus, each “module” herein may comprise circuitry.

Meanwhile, various elements and areas in the drawings are illustrated schematically. Accordingly, the technical idea of the disclosure is not limited by the relative sizes or intervals illustrated in the appended drawings.

Hereinafter, an embodiment of the disclosure is more specifically described with reference to the appended drawings.

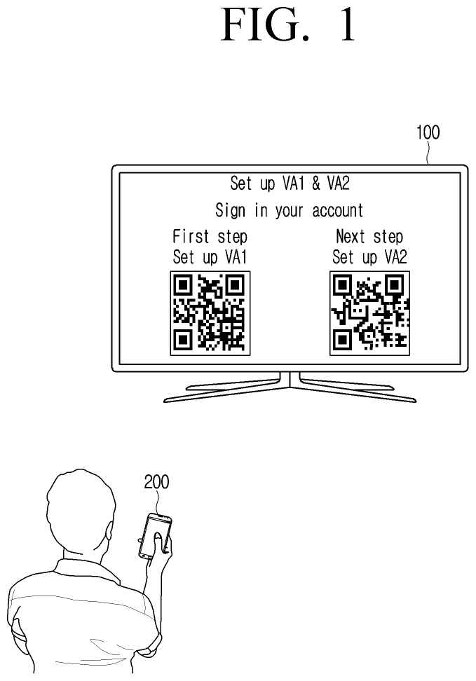

FIG. 1 is a view illustrating a system according to an embodiment.

With reference to FIG. 1, a display device 100 may onboard a plurality of voice assistants.

The voice assistants may provide a conversation with a user based on Artificial Intelligence (AI) such as Bixby and Alexa. For example, the voice assistants may receive a voice command, provide a response to a user as if the user have a conversation with a person, or control other devices.

“Onboarding” may mean to set up the voice assistants onto the display device 100 in order that the display device 100 provides the response to the voice command by using the voice assistants.

Meanwhile, if the plurality of voice assistants are onboarded to the display device 100, login using a user account may be required for each of the plurality of voice assistants. For the above, the display device 100 may display a plurality of QR codes in an onboarding process.

A QR code may include a Uniform Resource Locator (URL) of a server where login is performed based on a user account corresponding to a voice assistant. The server may provide a login screen through a web page corresponding to the URL. “Based on” as used herein covers based at least on.

The user may capture a plurality of QR codes displayed on the display device 100 by using the camera of the electronic device 200. In this case, the electronic device 200 may recognize the plurality of QR codes to obtain the URL from each of the plurality of QR codes. Further, the electronic device 200 may connect to a plurality of servers by using the plurality of URLs to display a login screen provided by each server. The user may generate a user account by using a login screen or perform login by using a user account owned previously. That is, the electronic device 200 may log in each server by using login information (e.g. a user account and a password) inputted to each of the plurality of login screens.

As above, if login is completed, the display device 100 may perform the remaining onboarding processes to complete onboarding of the plurality of voice assistants.

According to an example, the display device 100 may be implemented as a TV. Meanwhile, it is not limited thereto, and any device including a display may be the display device 100 according to the disclosure. Also, according to an embodiment, the electronic device 200 may be implemented as a smart phone or a tablet. Meanwhile, it is not limited thereto, and any device including a camera and a display may be the electronic device 200 according to the disclosure.

Meanwhile, order information of the plurality of voice assistances in the disclosure may indicate an order in which the plurality of voice assistants are onboarded to the display device 100 in the disclosure. A login process for the voice assistants may also proceed from a voice assistant where the onboarding process is started (or performed) in advance.

An order in which the plurality of voice assistants are onboarded to the display device 100 may be preset. That is, it may be preset from which voice assistant the onboarding process starts in advance and at which voice assistant the onboarding process starts next.

Also, in the disclosure, the QR code may include a URL of the server where login is performed based on a user account corresponding to the voice assistant. The server may provide a login screen through a web page corresponding to the URL.

Also, in the disclosure, an order UI may designate an order in which the voice assistants are onboarded to the display device 100 and may include at least one of a number or a character.

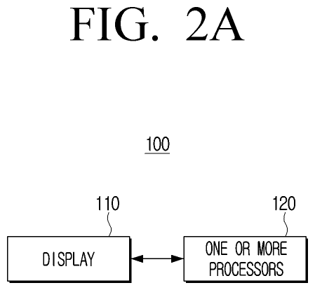

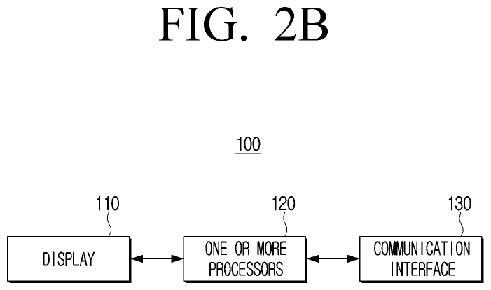

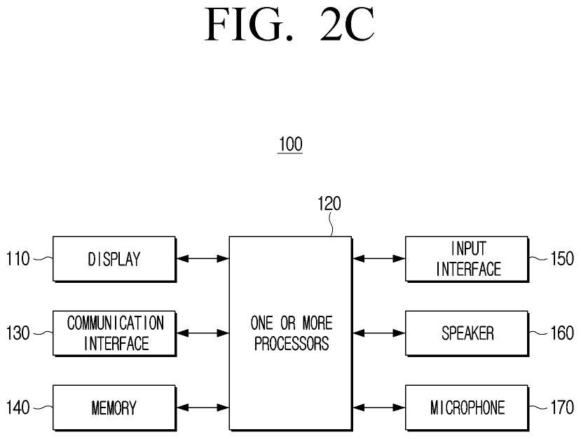

FIGS. 2A, 2B, and 2C are block diagrams illustrating a configuration of a display device according to an embodiment.

According to FIG. 2A, the display device 100 may include a display 110 and one or more processors 120.

The display 110 may display an image. For the above, the display 110 may be implemented as various types of displays such as a LCD, a LED, or an OLED. Also, the display 110 may be implemented as a flat display, a curved display, a foldable and/or rollable flexible display, etc.

The one or more processors 120 control the display device 100 overall.

Specifically, the one or more processors 120 may be connected to each component of the display device 100 to control operations of the display device 100 overall. For example, the one or more processors 120 may be electrically connected to the display 110 to control the operations of the display device 100 overall. The one or more processors 120 may be implemented as one processor or a plurality of processors.

The one or more processors 120 may perform operations of the display device 100 according to various embodiments by executing at least one instruction stored in the memory.

The one or more processors 120 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 120 may control one or any combination of other components of the display device 100 and perform an operation related to communication or data processing. The one or more processors 120 may perform one or more programs or instructions stored in the memory. For example, the one or more processors may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an AI-dedicated processor).

The one or more processors 120 may be implemented as a single core processor including one core and may be implemented as one or more multi core processors including a plurality of cores (e.g. homogeneous multicores or heterogeneous multicores). If the one or more processors 120 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, a processor may indicate a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, a machine learning accelerator, or the like but embodiments of the disclosure are not limited thereto.

Hereinafter, for convenience of the description, the one or processors 120 are referred to as a processor 120.

A processor 120 may receive a user command for onboarding a plurality of voice assistants to a display device 100.

Here, the user command may be inputted through a UI screen displayed on a display 110. For the above, the processor 120 may display the UI screen for selecting a voice assistant to be onboarded to the display device 100 on the display 110. In this case, a user may select an item displayed on the UI screen by using a button prepared on the display device 100 or a remote controller for controlling the display device 100 and input a user command for onboarding the plurality of voice assistants to the display device 100.

Further, the processor 120 controls the display 110 to display a screen including a plurality of QR codes corresponding to the plurality of voice assistants based on order information of the plurality of voice assistants.

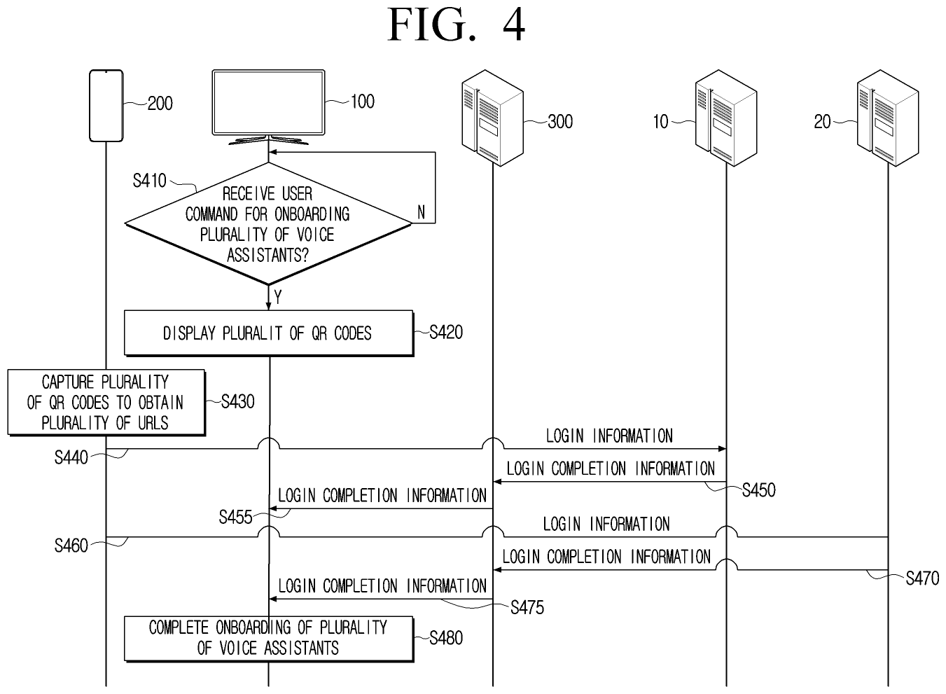

For the above, the processor 120 may obtain a plurality of QR codes. According to an embodiment, the plurality of QR codes may be provided from a server (e.g. 10 of FIG. 4). Here, the server may be a server where login for one assistant among the plurality of assistants onboarded to the display device 100 is performed.

The QR code may include a URL of a server where login is performed based on a user account corresponding to a voice account. The server may provide a login screen through a web page corresponding to the URL.

For the above, the processor 120 may obtain order information of a plurality of voice assistants.

According to an embodiment, the order information may be provided from the server (e.g. 10 of FIG. 4).

According to an example, the order information may be prestored in the display device 100.

Accordingly, the processor 120 may obtain order information of the plurality of voice assistants and display a screen including a plurality of QR codes on the display 110 by using the obtained order information.

According to an embodiment, the processor 120 may display a plurality of order UIs on the plurality of QR codes corresponding to the plurality of voice assistants based on the order information.

According to an embodiment, the processor 120 may sequentially activate a QR code corresponding to a voice assistant in an order where its onboarding order is fast based on the order information.

According to FIG. 2B, the electronic device 100 may include a display 110, a processor 120, and a communication interface 130. The detailed description of components overlapped with the components shown in FIG. 2A among the components shown in FIG. 2B is omitted.

The communication interface 130 may include circuitry. The communication interface 130 may perform communication with an external device. Here, the external device may include an electronic device 200 and a server.

The communication interface 130 may support various communication methods according to an embodiment of the display device 100. For example, the communication interface 130 may perform communication with an external device through a communication method such as Bluetooth, ZigBee, AP based Wi-Fi (Wi-Fi, a Wireless LAN network), a wired/wireless Local Area Network (LAN), a Wide Area Network (WAN), or Ethernet.

According to an embodiment, the processor 120 may receive a plurality of QR codes and order information of the plurality of voice assistants from the server through the communication interface 130.

With reference to FIG. 2C, the display device 100 may include a display 110, a processor 120, a communication interface 130, memory 140, an input interface 150, a speaker 160, and a microphone 170. However, the above configuration is exemplary. A new configuration may be added to the above configuration, or part of the configuration may be omitted. The detailed description of components overlapped with the components shown in FIGS. 2A and 2B among the components shown in FIG. 2C is omitted.

The memory 140 may store data required for various embodiments. According to an embodiment, the memory 140 may store order information of the plurality of voice assistants. In this case, the processor 120 may obtain order information of the plurality of voice assistants from the memory 140.

The memory 140 may be implemented as memory embedded in the display device 100 according to a use for data storage or may be implemented as memory detachable from the display device 100.

For example, memory embedded in the electronic device 100 may be implemented as at least one of volatile memory (e.g. dynamic RAM (DRAM), static RAM (SRAM), or synchronous dynamic RAM (SDRAM, etc.)), non-volatile memory (e.g. one time programmable ROM (OTPROM), programmable ROM (PROM), erasable and programmable ROM (EPROM), electrically erasable and programmable ROM (EEPROM), mask ROM, or flash ROM, flash memory (e.g. NAND flash memory or NOR flash memory, etc.), a hard drive, or a solid state drive (SSD)).

Also, memory detachable from the display device 100 may be implemented as a memory card (e.g. a compact flash (CF) card, a secure digital (SD) card, a micro secure digital (Micro-SD) card, a mini secure digital (Mini-SD) card, an extreme digital (xD) card, a multi-media card (MMC), etc.), external memory connectable to a USB port (e.g. USB memory), etc.

The memory 140 may store at least one instruction for driving the display device 100. In this case, the processor 120 may perform operations of the display device 100 according to various embodiments by executing the at least one instruction stored in the memory 140. Also, the memory 140 may store a program and data for driving the display device 100.

The input interface 150 includes circuitry. The processor 120 may receive a user command for controlling operations of the electronic device 200 through the input interface 150. As an example, the input interface 150 may be configured of a plurality of buttons. As an example, the input interface 150 may receive a remote controller signal from a remote controller for controlling the display device 100. As an example, the input interface 150 may be implemented as a touch screen. In this case, the processor 120, if the user command is received through the input interface 150, may perform an operation corresponding to the user input.

The speaker 160 may output audio sound. According to an embodiment, the processor 120 may output audio sound related to an operation of the display device 100 through the speaker 160.

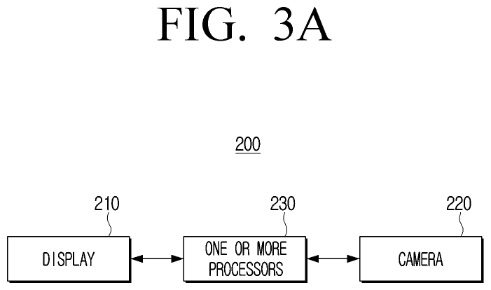

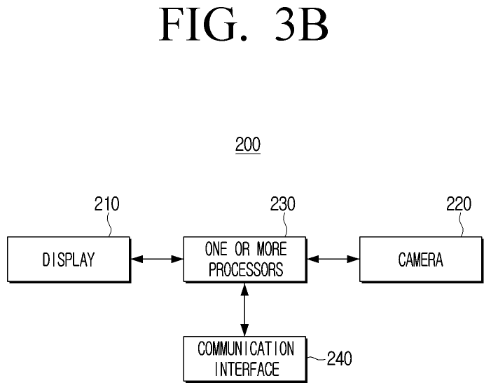

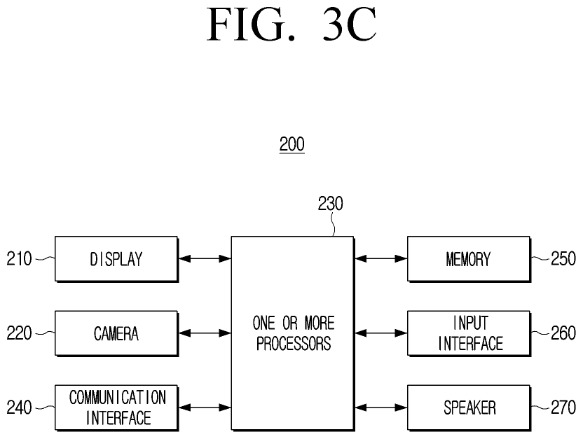

The microphone 170 may receive a voice. According to an embodiment, the processor 120 may transmit the voice inputted through the microphone 170 to a server providing a voice assistant through the communication interface 130 and output a response received through the communication interface 130 though the speaker 160. FIGS. 3A, 3B, and 3C are block diagrams illustrating a configuration of an electronic device according to an embodiment.

With reference to 3A, the electronic device 200 includes a display 210, a camera 220, and one or more processors 230.

The display 210 may display an image. For the above, the display 210 may be implemented as various types of displays such as a LCD, a LED, or an OLED. Otherwise, the display 210 may be implemented as a flat display, a curved display, a foldable and/or rollable flexible display, etc.

According to an embodiment, on the front of the display 210, a touch sensor for detecting various types of touch inputs may be arranged. For example, the display 210 may detect various types of touch inputs such as a touch input by a user hand, a touch input by an input device such as a stylus pen, or a touch input by a specific electrostatic material. Here, the input device may be implemented as an input device having a pen shape which may be referred to as various terms such as an electronic pen, a stylus pen, or a S-pen.

The camera 220 may perform a function of capturing a capture object. For the above, the camera 220 may include an image sensor and a lens.

The one or more processors 230 controls the electronic device 200 overall. Specifically, the one or more processors 230 may be connected to each component of the electronic device 100 to control operations of the electronic device 100 overall. For example, the one or more processors 230 may be electrically connected to the display 210 and the camera 220 to control the operations of the electronic device 200 overall. The one or more processors 230 may be implemented as one processor or a plurality of processors.

The one or more processors 230 may perform operations of the electronic device 200 according to various embodiments by executing at least one instruction stored in the memory.

The one or more processors 230 may include one or more of a CPU, a GPU, an APU, a MIC, a DSP, a NPU, a hardware accelerator, or a machine learning accelerator. The one or more processors 230 may control one or any combination of other components of the electronic device 200 and perform an operation related to communication or data processing. The one or more processors 230 may perform one or more programs or instructions stored in the memory. For example, the one or more processors may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an AI-dedicated processor).

The one or more processors 230 may be implemented as a single core processor including one core and may be implemented as one or more multi core processors including a plurality of cores (e.g. homogeneous multicores or heterogeneous multicores). If the one or more processors 230 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, a processor may indicate a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, a machine learning accelerator, or the like but embodiments of the disclosure are not limited thereto.

Hereinafter, for convenience of the description, the one or processors 230 are referred to as a processor 230.

The processor 230 may obtain an image capturing a plurality of QR codes displayed on the display device 100 by using the camera 220 and display the obtained image on the display 210. Further, the processor 230 may store the obtained image in memory of the electronic device 200.

Here, to obtain and display the image may indicate to capture a live view image and then display the captured image rather than to display the live view image. That is, the live view image may indicate an image where light incident through a lens of the camera 220 is converted to an electric image signal by an image sensor of the camera and the image is displayed on the display 210 of the electronic device 200. Meanwhile, to capture the live view image may indicate to obtain an image frame corresponding to a specific time point (e.g. a time point when a user command for capture is inputted) to store the image frame in the electronic device 200. In this case, the storing is different from storing image frames for the live view image in volatile memory such as a frame buffer and may indicate that the image frames are stored in non-volatile memory such as flash memory of the electronic device 200.

Further, the processor 230 controls the display 210 to display a UI corresponding to a QR code and a URL obtained from the QR code based on order information of a plurality of voice assistants corresponding to the plurality of QR codes.

For the above, the processor 230 may obtain the order information of the plurality of voice assistants.

According to an embodiment, the order information of the plurality of voice assistants may be provided by the display device 100. The processor 120 may transmit location information where the plurality of QR codes are displayed on the display 110 and order information of a voice assistant corresponding to each QR code according to the location information to the electronic device 200 through the communication interface 130. Accordingly, the processor 230 may identify order information of a voice assistant corresponding to a QR code per QR code displayed on the display device 100 based on the received information.

According to an embodiment, the order information of the plurality of voice assistants may be prestored in the electronic device 200.

According to an embodiment, order information of the plurality of voice assistants may be obtained from the plurality of QR codes. Specifically, when the plurality of QR codes are generated, a URL where login of a user account corresponding to a voice assistant corresponding to each QR code is performed and order information of a voice assistant corresponding to each QR code may be added to each QR code. In this case, the processor 230 may recognize each of the plurality of QR codes included in the image obtained through the camera 220 and obtain order information of a voice assistant from the QR code.

According to an embodiment, the processor 230 may obtain order information of the plurality of voice assistants by using a plurality of order UIs displayed on the plurality of QR codes. Specifically, as aforementioned, each of the plurality of order UIs may designate an order in which the voice assistants are onboarded to the display device 100 and may include at least one of a number or a character. The processor 230 may recognize a number or a character displayed on the plurality of QR codes in the image obtained through the camera 200 and identify order information of the plurality of voice assistants corresponding to the plurality of QR codes.

Accordingly, the processor 230 may obtain order information of the plurality of voice assistants and display a screen including a plurality of QR codes on the display 110 by using the obtained order information.

According to an embodiment, the processor 230 may sequentially focus on and display a QR code corresponding to a voice assistant in an order where its onboarding order is fast based on the order information. Here, the focus may indicate a GUI displayed for distinguishing a QR code from another QR code. Further, the focusing and displaying is to display a focus on the QR code, wherein as an example, it may include various methods such as highlighting and displaying the QR code, displaying an edge part of the QR code in a different color, displaying the QR code three-dimensionally, or adding a specific image such as an arrow.

According to an embodiment, the processor 230 may display a plurality of order UIs on the plurality of QR codes based the order information.

According to an embodiment, the processor 230 may sequentially display a URL corresponding to a voice assistant in an order where its onboarding order is fast based on the order information.

According to an embodiment, the processor 230 may display a plurality of order UIs on the plurality of URLs based on the order information.

With reference to FIG. 3B, the electronic device 200 may include a display 210, a camera 220, a processor 230, and a communication interface 240. The detailed description of components overlapped with the components shown in FIG. 3A among the components shown in FIG. 3B is omitted.

The communication interface 240 includes circuitry. The communication interface 240 may perform communication with an external device. Here, the external device may include a display device 100 and a server. According to an embodiment, the processor 230 may receive order information of the plurality of voice assistants from the server through the communication interface 240.

The communication interface 240 may support various communication methods according to an embodiment of the electronic device 200. For example, the communication interface 240 may perform communication with the external device though a communication method such as Bluetooth, ZigBee, AP based Wi-Fi, a 3rd Generation (3G), a 3rd Generation Partnership Project (3GPP), Long Term Evolution (LTE), a 5th Generation (5G), a wired/wireless LAN, a WAN, or Ethernet.

With reference to FIG. 3C, an electronic device 200 may include a display 210, a camera 220, a processor 230, a communication interface 240, memory 250, an input interface 260, and a speaker 270. However, the above configuration is exemplary. In implementing the disclosure, a new configuration may be added to the above configuration, or part of the configuration may be omitted. The detailed description of components overlapped with the components shown in FIGS. 3A and 3B among the components shown in FIG. 3C is omitted.

The memory 250 may store data required for various embodiments. According to an embodiment, the memory 250 may store order information of the plurality of voice assistants. In this case, the processor 230 may obtain order information of the plurality of voice assistants from the memory 250. The memory 250 may be implemented as memory embedded in an electronic device 200 according to a use for data storage or may be implemented as memory detachable from the electronic device 200.

For example, memory embedded in the electronic device 200 may be implemented as at least one of volatile memory (e.g. DRAM, SRAM, or SDRAM) or non-volatile memory (e.g. OTPROM, PROM, EPROM, EEPROM, mask ROM, or flash ROM, flash memory (e.g. NAND flash memory or NOR flash memory), a hard drive, or a solid state drive (SSD)).

Also, memory detachable from the electronic apparatus 200 may be implemented as a memory card (e.g. a CF card, a SD card, a Micro-SD card, a Mini-SD, an xD card, a MMC, etc.), external memory connectable to a USB port (e.g. USB memory), etc.

The memory 250 may store at least one instruction for driving the electronic device 200. In this case, the processor 230 may perform operations of the electronic device 200 according to various embodiments by executing at least one instruction stored in the memory 250. Also, the memory 250 may store a program and data for driving the electronic device 200.

The input interface 260 includes circuitry. The input interface 260 may receive a user command. As an example, the input interface 260 may be implemented as a touch screen which may perform a display function and an input function of a user command together. In this case, the input interface 260 may be implemented in a form included in the display 210. The processor 230, if the user command is received through the input interface 260, may perform an operation corresponding to the user input.

The speaker 270 may output audio sound. Specifically, the processor 230 may output audio sound related to an operation of the electronic device 200 through the speaker 270.

FIG. 4 is a flow chart illustrating a method of onboarding a plurality of voice assistants to a display device by using an electronic device according to an embodiment.

With reference to FIG. 4, a processor 120 may receive a user command for onboarding a plurality of voice assistants to a display device 100 (S410-Y).

Here, the user command may be inputted through a UI screen displayed on a display 110.

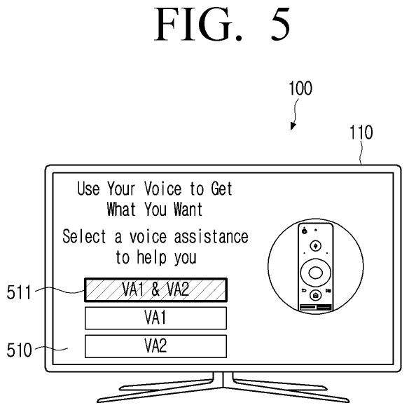

According to an embodiment, as shown in FIG. 5, the processor 120 may display a UI screen 510 for selecting a voice assistant to be onboarded to the display device 100 on the display 110. In this case, the user may select an item 511 for selecting a voice assistant 1 (e.g. VA 1) and a voice assistant 2 (e.g. VA 2) and input a user command for onboarding the voice assistant 1 and the voice assistant 2 to the display device 100.

Then, the processor 120 may display a screen including a plurality of QR codes on the display 110 (S420).

For the above, the processor 120 may obtain the plurality of QR codes corresponding to the plurality of voice assistants.

According to an embodiment, the processor 120, if a user command for onboarding the plurality of voice assistants is received, may request login to a server 300 through the communication interface 130. In this case, the request for login includes information about the voice assistants to be onboarded to the display device 100.

The server 300 may be a server providing a voice assistant service or a server which may be connected to the relevant server to provide a voice assistant service. The server 300 may transmit (or redirect) the request for login to a server 10. The server 10 may generate a plurality of QR codes according to the request for login and transmit the plurality of QR codes to the display device 100.

As aforementioned, it is assumed that the voice assistant 1 and the voice assistant 2 are onboarded to the display device 100.

In this case, the server 10 may generate a QR code including a URL to which a login screen for the voice assistant 1 is provided and a QR code including a URL to which a login screen for the voice assistant 2 is provided and transmit the plurality of generated QR codes to the display device 100.

Meanwhile, the user may capture a plurality of QR codes displayed on the display 110 by using the camera 220 of the electronic device 200. In this case, the processor 230 may recognize the plurality of QR codes to obtain the URL from each of the plurality of QR codes (S430).

Further, the processor 230 may connect to a plurality of servers 10, 20 through the communication interface 240 by using a plurality of URLs and display a login screen provided by each server 10, 20 on the display 210. The user may generate a user account by using the login screen or perform login by using the user account owned previously. The processor 230 may log in each server 10, 20 by using login information inputted to each of a plurality of login screens (S440, 460).

The server 10, 20, if login is performed, may transmit login completion information to the server 300 (S450, S470). The processor 120, if the login completion information is received from the server 300 (S455, S475), may perform the remaining onboarding process and complete onboarding of the plurality of voice assistants (S480).

Meanwhile, the processor 120, if the onboarding of the plurality of voice assistants is completed, may provide a response to a voice of the user by using the plurality of voice assistants. In this case, a voice assistant providing a response may be selected according to a trigger input (e.g. a wake-up call speech).

According to an embodiment, the processor 120, if the trigger input corresponding to the voice assistant 1 is received, may transmit a voice to the server 300 providing the voice assistant 1 through the communication interface 130 and receive a response from the server 300 through the communication interface 130. Also, the processor 120, if the trigger input corresponding to the voice assistant 2 is received, may transmit a voice to a server (not shown) providing the voice assistant 2 through the communication interface 130 and receive a response from the server (not shown) through the communication interface 130.

As above, in the disclosure, the plurality of QR codes for the plurality of login corresponding to the plurality of voice assistants may be included in one screen and be provided to the user. Accordingly, the onboarding process may proceed faster and a more intuitive user experience may be provided compared to a case of sequentially providing the plurality of QR codes.

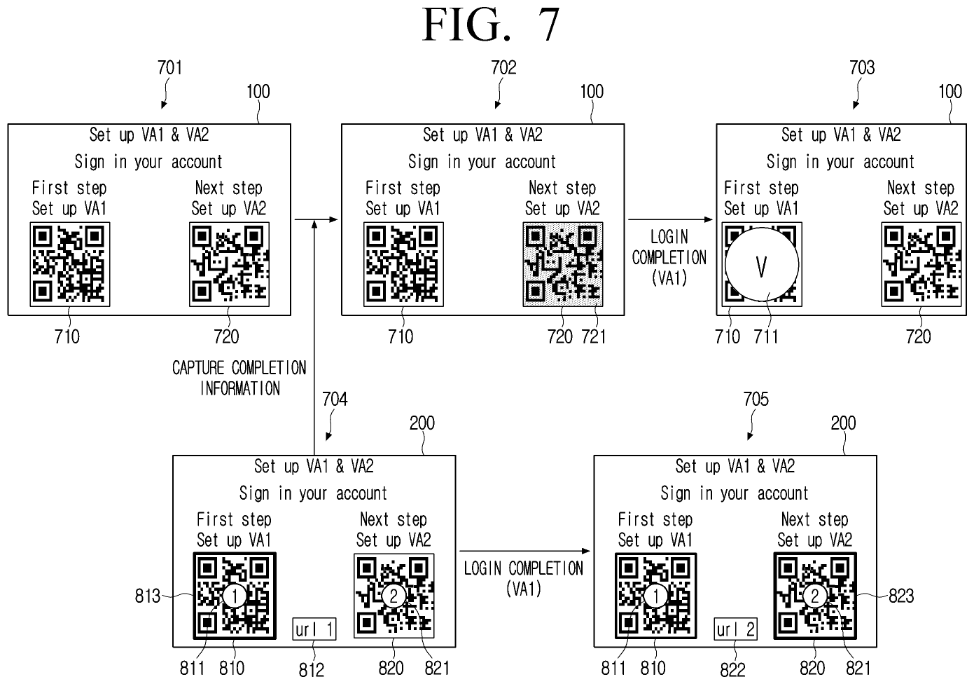

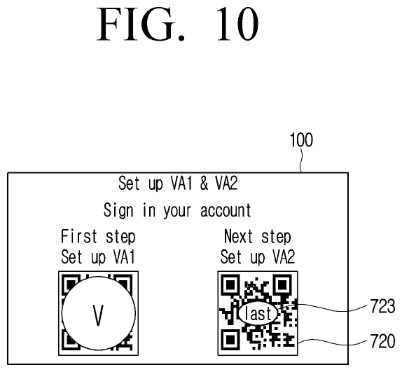

Hereinafter, with reference to the appended drawings, a method of onboarding a plurality of voice assistants to a display device by using an electronic device is specifically described. In this case, in FIGS. 7, 9, 10, 12, and 13, a reference numeral 100 designates a screen displayed on a display device 100 and a reference numeral 200 designate a screen displayed on an electronic device 200.

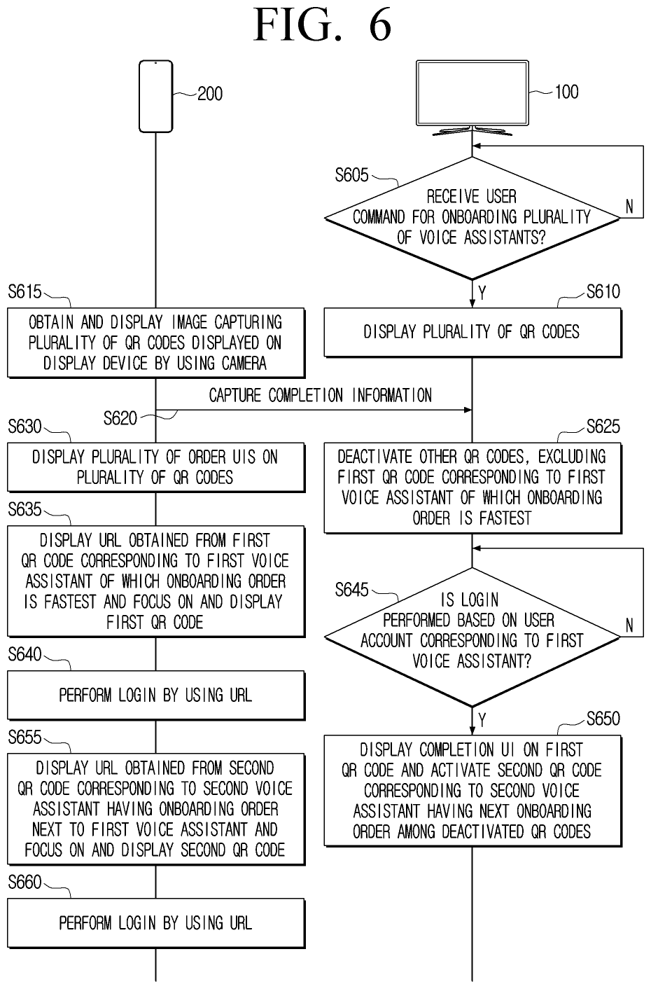

FIG. 6 is a flow chart illustrating a method of onboarding a plurality of voice assistants to a display device by using an electronic device according to an embodiment.

With reference to FIG. 6, a processor 120, if a user command for onboarding a plurality of voice assistants to a display device 100 is received (S605-Y), may display a plurality of QR codes on the display device 100 (S610).

For example, it is assumed that the voice assistant 1 and the voice assistant 2 are onboarded to the display device 100.

In this case, as shown in 701 of FIG. 7, the processor 120 may display a QR code 710 corresponding to the voice assistant 1 and a QR code 720 corresponding to the voice assistant 2 on the display 110.

Meanwhile, a user may capture a plurality of QR codes displayed on the display 110 by using a camera 220 of the electronic device 200.

In this case, the processor 230 may obtain an image capturing a plurality of QR codes displayed on the display device 100 and display the obtained image on the display 210 (S615). Further, the processor 230 may store the obtained image in memory 250.

According to an embodiment, the processor 230, if a user command for capture is inputted, may perform capture to obtain an image including a plurality of QR codes. In this case, the user command may be, for example, a command of a user who selects a capturing item included in a user interface provided through a camera application.

According to an embodiment, the processor 230, if a plurality of QR codes are detected from an image captured by the camera 220, may automatically perform capture and obtain an image including the plurality of QR codes.

Further, the processor 230, if an image including the plurality of QR codes is obtained, may transmit capture completion information to the display device 100 through the communication interface 240 (S620).

Meanwhile, the processor 120, if the capture completion information is received from the electronic device 200 obtaining the image including the plurality of QR codes displayed on the display 110 through the communication interface 130, may deactivate the other QR codes, excluding a first QR code corresponding to a first voice assistant of which an onboarding order is the fastest among the plurality of QR codes displayed on the display 110 based on order information of the plurality of voice assistants (S625).

Here, the deactivating the QR codes may indicate performing dimming, blur, or translucence processing on the QR codes.

For example, it is assumed that an onboarding order of the voice assistant 1 is faster than an onboarding order of the voice assistant 2.

In this case, the processor 120, if capture completion information is received, may perform dimming 721 processing on the QR code 720 corresponding to the voice assistant 2 and display the same as shown in 702 of FIG. 7.

Meanwhile, the processor 230 may display a plurality of order UIs indicating an order in which the plurality of voice assistants are onboarded to the display device 100 on the plurality of QR codes based on the order information of the plurality of voice assistants (S630). In this case, the processor 230 may display the plurality of order UIs in a 3D form.

According to an embodiment, as shown in 704 of FIG. 7, the processor 230 may display an order UI 811 on a QR code 810 and display an order UI 821 on a QR code 820.

In this case, the order UI 811 may include 1 in that the onboarding order of the voice assistant 1 is the first, and the order UI 821 may include 2 in that the onboarding order of the voice assistant 2 is the second.

Further, the processor 230 may display a URL obtained from a first QR code corresponding to a first voice assistant of which an onboarding order is the fastest among the plurality of voice assistants based on the order information of the plurality of voice assistants (S635). For the above, the processor 230 may recognize a first QR code among the plurality of QR codes included in the image and obtain a URL from the first QR code.

According to an embodiment, as shown in 704 of FIG. 7, the processor 230 may display the URL 1 812 in a pop-up form on an image including the QR codes 810, 820. Here, the URL 1 812 may be a URL obtained from the QR code 810.

Also, the processor 230 may focus on and display the first QR code corresponding to the first voice assistant of which an onboarding order is the fastest among the plurality of voice assistants based on the order information of the plurality of voice assistants (S635).

According to an embodiment, as shown in 704 of FIG. 7, the processor 230 may display an edge part of the QR code 810 in a different color.

Meanwhile, in spite of being not shown in 704 of FIG. 7, the processor 230 may deactivate the other QR codes, excluding a first QR code among the plurality of QR codes. Here, the deactivating the QR codes may indicate performing dimming, blur, or translucence processing on the QR codes.

Then, the processor 230 may connect to the server 10 by using a URL obtained from the first QR code and display a login screen provided by the server 10 on the display 210. According to an embodiment, the processor 230 may automatically connect to the server 10 by inputting touch manipulation onto the URL displayed on the display 210 or using the URL.

Further, the processor 230 may log in the server 10 by using login information inputted to a login screen (S640).

Meanwhile, the processor 120 may identify whether login is performed based on a user account corresponding to a first voice assistant (S645).

Specifically, the processor 230 may log in the server 10 by using the login information inputted to the login screen. The server 10, if login is performed, may transmit login completion information to the display device 100 through the server 300. Accordingly, the processor 120, if the login completion information is received through the communication interface 130, may identify that the login is performed based on the user account corresponding to the first voice assistant.

Then, the processor 120, if login is performed based on the user account corresponding to the first voice assistant (S645-Y), may display a completion UI on the first QR code and activate a second QR code corresponding to a second voice assistant having an onboarding order next to the first voice assistant among the other deactivated QR codes (S650).

Here, the activating the deactivated QR codes may indicate removing dimming, blur, or translucence processing from the QR codes.

According to an embodiment, the processor 120, if login for the voice assistant 1 is completed, may display a completion UI 711 on the QR code 710 corresponding to the voice assistant 1 and remove dimming processing from the dimming processed QR code 720 as shown 703 of FIG. 7.

Also, the processor 120 may renew an expiration time of the activated QR code. According to an example, there may be a period of validity of the QR code. In this case, the processor 120 may activate the deactivated QR code and request renewal of the expiration time of the activated QR code to the authentication server 10.

Meanwhile, the processor 230, if login is performed based on the user account corresponding to the first voice assistant, may display a URL obtained from a second QR code corresponding to a second voice assistant having an onboarding order next to the first voice assistant based on the order information of the plurality of voice assistants (S655). For the above, the processor 230 may recognize a second QR code among the plurality of QR codes included in the image and obtain a URL from the second QR code.

According to an embodiment, as shown in 705 of FIG. 7, the processor 230 may display the URL 2 822 in a pop-up form on an image including the QR codes 810, 820. Here, the URL 2 822 may be a URL obtained from the QR code 820.

Also, the processor 230 may focus on and display a second QR code corresponding to a second voice assistant having an onboarding order next to the first voice assistant based on the order information of the plurality of voice assistants (S655).

According to an embodiment, as shown in 705 of FIG. 7, the processor

230 may display an edge part of the QR code 820 in a different color.

Meanwhile, in spite of being not shown in 705 of FIG. 7, the processor 230, if the other QR codes are deactivated, excluding the first QR code, may activate the second QR code corresponding to the second voice assistant having the next onboarding order among the deactivated QR codes.

Also, in spite of being not shown in 705 of FIG. 7, the processor 230 may display a completion UI on the first QR code corresponding to the voice assistant where login is performed.

Then, the processor 230 may connect to the server 20 by using a URL obtained from the second QR code and display a login screen provided by the server 20 on the display 210. According to an embodiment, the processor 230 may automatically connect to the server 20 by inputting touch manipulation onto the URL displayed on the display 210 or using the URL.

Further, the processor 230 may log in the server 20 by using login information inputted to a login screen (S660).

Meanwhile, the server 20, if login is performed, may transmit login completion information to the display device 100 through the server 300. In this case, the processor 120 may identify that login for the plurality of voice assistants is completed, perform the remaining onboarding process, and complete onboarding of the plurality of voice assistants.

As above, the display device 100 and the electronic device 200 may interactively display various UIs related to login performed upon the onboarding process. Accordingly, the user may easily recognize for which voice assistant a login process is performed for onboarding and easily perform login.

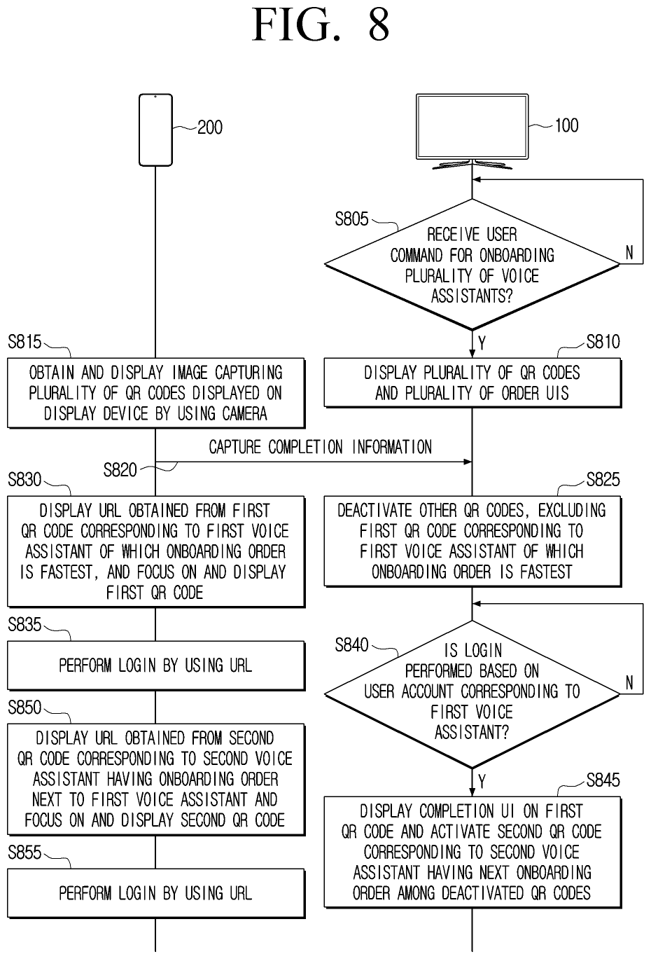

FIG. 8 is a flow chart illustrating a method of onboarding a plurality of voice assistants to a display device by using an electronic device according to an embodiment.

FIG. 8 is different from FIG. 6 in that the display device 100 displays a plurality of order UIs on the plurality of QR codes. Meanwhile, excluding the above content, the other contents are the same as those of FIG. 6 and thus, the detailed description about the overlapped content is omitted.

With reference to FIG. 8, a processor 120, if a user command for onboarding a plurality of voice assistants to a display device 100 is received (S805-Y), may display a plurality of QR codes on the display device 100 (S810).

In this case, the processor 120 may display a plurality of order UIs on the plurality of QR codes based the order information of the plurality of voice assistants (S810).

Specifically, a frame QR code includes a canvas area. The canvas area may indicate an area which does not affect recognition of the QR code and may be freely used within the QR code. According to an embodiment, a server 10 may generate a plurality of QR codes by using the frame QR code. In this case, information about a URL where login of a user account corresponding to a voice assistant is performed may be included in the area, excluding the canvas area from each of the plurality of QR codes.

In this case, the processor 120 may display an order UI on a preset area of the QR code. Here, the preset area may be the canvas area.

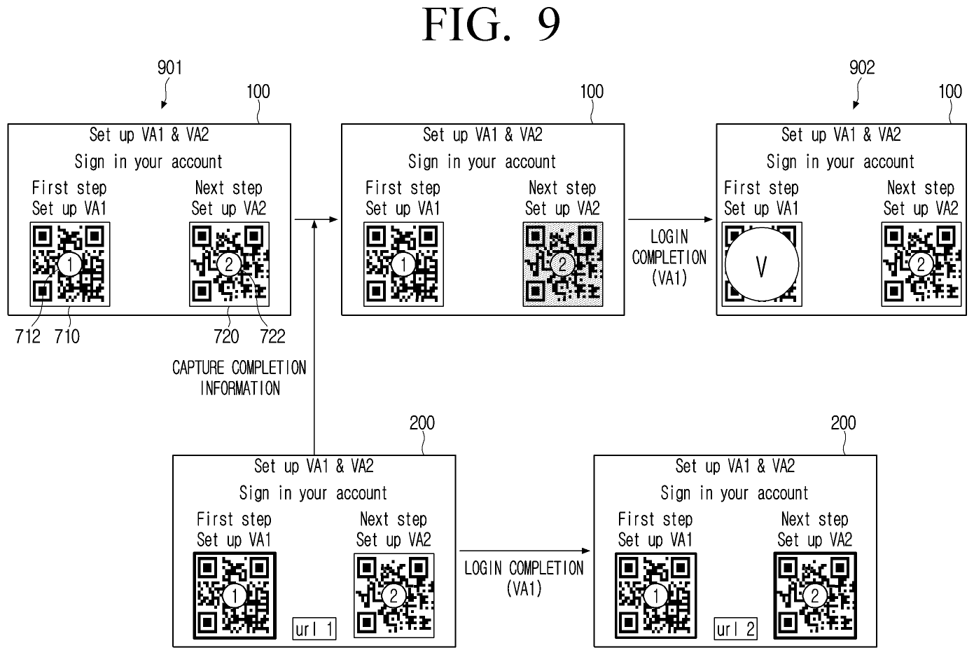

According to an embodiment, as shown in 901 of FIG. 9, the processor 120 may display an order UI 712 on a QR code 710 and display a UI 722 on a QR code 720. In this case, the order UI 712 includes 1 and may be positioned in the canvas area of the QR code 710 in that an onboarding order of a voice assistant 1 is the first. Also, the order UI 722 includes 2 and may be positioned in the canvas area of the QR code 720 in that an onboarding order of a voice assistant 2 is the second.

Meanwhile, according to an embodiment, when the server 10 generates a plurality of QR codes, an order UI may be added to each QR code. In this case, the processor 120 may display the plurality of QR codes received from the server 10 on the display 110.

Meanwhile, the processor 230 may obtain an image capturing the plurality of QR codes displayed on the display device 100 and display the obtained image on the display 210 (S815). Further, the processor 230 may transmit the capture completion information to the display device 100 through the communication interface 240 (S820).

The processor 120, if the capture completion information is received from the electronic device 200, may deactivate the other QR codes, excluding the first QR code corresponding to the first voice assistant of which an onboarding order is the fastest among the plurality of QR codes displayed on the display 110 based on the order information of the plurality of voice assistants (S825).

As aforementioned, the display device 100 may display the plurality of order UIs on the plurality of QR codes. Therefore, the image obtained by the electronic device 200 through capturing the plurality of QR codes may also include the plurality of order UIs. Accordingly, the step S630 of FIG. 6 may be omitted from FIG. 8.

In this case, the processor 230 may obtain order information of the plurality of voice assistants by using the plurality of order UIs included in the image obtained by the camera 220.

Then, the processor 230 may display a URL obtained from the first QR code corresponding to the first voice assistant of which an onboarding order is the fastest among the plurality of voice assistants based on the order information of the plurality of voice assistants and may focus on and display the first QR code (S830).

Then, the processor 230 may log in the server 10 by using a URL obtained from the first QR code (S835).

Meanwhile, the processor 120, if it is identified that login is performed based on the user account corresponding to the first voice assistant (S840-Y), may display a completion UI on the first QR code and activate a second QR code corresponding to a second voice assistant having an onboarding order next to the first voice assistant among the other deactivated QR codes (S845).

Meanwhile, the processor 230, if login is performed based on the user account corresponding to the first voice assistant, may display a URL obtained from a second QR code corresponding to a second voice assistant having an onboarding order next to the first voice assistant based on the order information of the plurality of voice assistants and may focus on and display the second QR code (S850).

Then, the processor 230 may log in the server 20 by using the URL obtained from the second QR code (S855).

According to an embodiment, the processor 120 may change a type of order UI to another type.

Here, the type of order UI may be different depending on an element configuring a UI. According to an embodiment, if the type of order UI is a first type, the order UI may include a number indicating an onboarding order of the voice assistants. Also, if the type of order UI is a second type, the order UI may include a character indicating an onboarding order of the voice assistants. Here, the character may include contextual information according to the onboarding order. For example, if a voice assistant corresponding to the QR code is a voice assistant that remains lastly in the onboarding process, the second type of order UI indicated on the QR code may include a character such as “last”.

Meanwhile, with reference to FIG. 8, the processor 120, if login is performed based on a user account corresponding to the first voice assistant (S840-Y), may activate the deactivated second QR code (S845). In this case, as shown in 902 of FIG. 9, the order UI originally displayed on the second QR code, that is, the order UI including “2” may be displayed.

Meanwhile, the processor 120, if login is performed based on a user account corresponding to the first voice assistant (S840-Y), may change the first type of order UI displayed on a preset area within the second QR code to the second type of order UI.

According to an embodiment, the processor 120, if a login process for the voice assistant 1 is completed, may change “2” displayed on the QR code 720 to “last” 723. Accordingly, the user may more easily recognize the login process for the lastly remaining voice assistant thanks to the currently proceeding login process.

In the aforementioned examples, the electronic device 200 sequentially displays URLs obtained from the QR code. Meanwhile, according to an embodiment, the electronic device 200 may display a plurality of URLs. That is, the processor 230 may display the plurality of order URLs on the image based on the order information of the plurality of voice assistants.

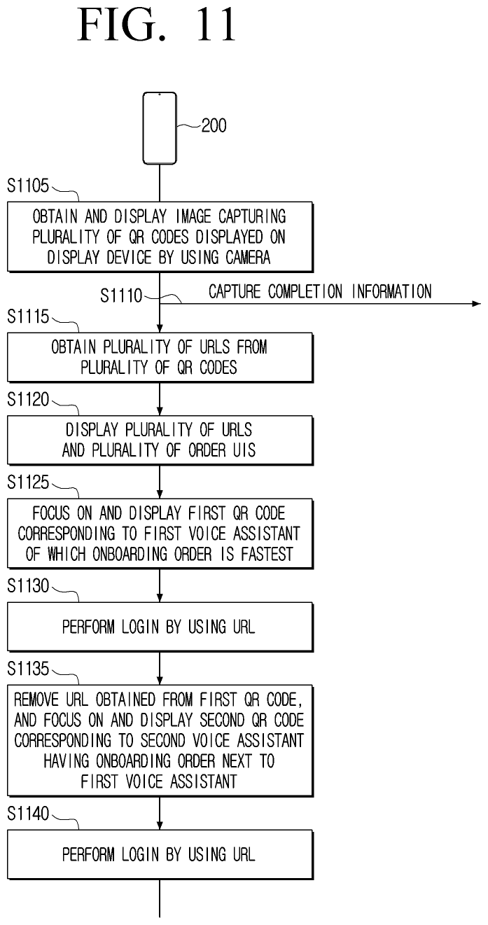

FIG. 11 is a flow chart illustrating a method in which an electronic device displays a plurality of order UIs on a plurality of URLs according to an embodiment.

FIG. 11 is different from FIGS. 6 and 8 in that the electronic device 200 displays the plurality of URLs. Meanwhile, the other contents of FIG. 11 are the same as those of FIGS. 6 and 8, excluding the above content and thus, the detailed description about the overlapped content is omitted.

Also, FIG. 11 shows only a flow chart illustrating an operation of the electronic device 200. Meanwhile, this is for convenience for the description, wherein the operation of the display device 100 described in FIGS. 6 and 8 may apply to FIG. 11.

With reference to FIG. 11, the processor 230 may obtain an image capturing a plurality of QR codes displayed on the display device 100 by using the camera 220 and display the obtained image on the display 210 (S1105). Further, the processor 230 may transmit the capture completion information to the display device 100 through the communication interface 240 (S1110).

Then, the processor 230 may recognize a plurality of QR codes included in the image to obtain a plurality of URLs from a plurality of QR codes (S1115) and display the plurality of URLs and a plurality of order UIs (S1120). In this case, the processor 230 may display the plurality of URLs on the image in a pop-up form.

Specifically, the processor 230 may display the plurality of URLs and display a plurality of order UIs indicating an order in which the plurality of voice assistants are onboarded to the display device 100 on the plurality of URLs based on the order information of the plurality of voice assistants.

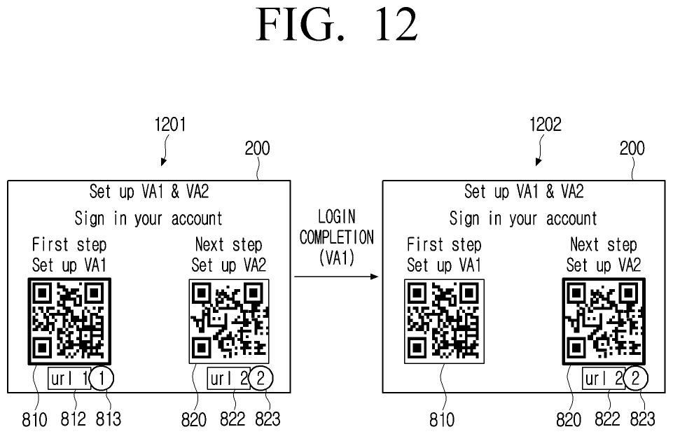

According to an embodiment, as shown in 1201 of FIG. 12, the processor 230 may display the URL 1 812 and URL 2 822 in a pop-up form on an image including the QR codes 810, 820. Here, the URL 1 812 is a URL obtained from the QR code 810, and the URL 2 822 is a URL obtained from the QR code 820. Also, the processor 230 may display an order UI 813 on the URL 1 812 and may display an order UI 823 on the URL 2 822. In this case, the order UI 812 may include 1 in that an onboarding order of the voice assistant 1 is the first, and the order UI 823 may include 2 in that an onboarding order of the voice assistant 2 is the second.

Also, the processor 230 may focus on and display the first QR code corresponding to the first voice assistant of which an onboarding order is the fastest among the plurality of voice assistants based on the order information of the plurality of voice assistants (S1125).

Then, the processor 230 may log in the server 10 by using a URL obtained from the first QR code corresponding to the first voice assistant of which an onboarding order is the fastest among the plurality of URLs (S1130).

Further, the processor 230, if login is performed based on the user account corresponding to the first voice assistant, may remove the URL obtained from the first QR code displayed on the image (S1135). That is, the processor 230 may remove the URL obtained from the first QR code in that the login process using the URL obtained from the first QR code is completed.

According to an embodiment, as shown in 1202 of FIG. 12, login is performed based on the user account corresponding to the first voice assistant, the URL 1 812 is not displayed but only the URL 2 822 may be displayed.

Then, the processor 230 may focus on and display a second QR code corresponding to a second voice assistant having an onboarding order next to the first voice assistant based on the order information of the plurality of voice assistants (S1135).

Thereafter, the processor 230 may log in the server 20 by using a URL obtained from the second QR code corresponding to the second voice assistant having an onboarding order next to the first voice assistant among the plurality of URLs (S1140).

According to an embodiment, the processor 230 may change a type of order UI to another type.

Here, the type of order UI may be different depending on an element configuring a UI. According to an embodiment, if the type of order UI is a first type, the order UI may include a number indicating an onboarding order of the voice assistants. Also, if the type of order UI is a second type, the order UI may include a character indicating an onboarding order of the voice assistants. Here, the character may include contextual information according to the onboarding order. For example, if a voice assistant corresponding to the QR code is a voice assistant that remains lastly in the onboarding process, the second type of order UI indicated on the QR code may include a character such as “last”.

Meanwhile, with reference to FIG. 11, the processor 120, if login is performed based on a user account corresponding to the first voice assistant, may remove the URL obtained from the first QR code (1135). In this case, as shown in 1202 of FIG. 12, the order UI originally displayed on the URL 2 822, that is, the order UI including “2” may be displayed.

Meanwhile, the processor 230, if login is performed based on a user account corresponding to the first voice assistant, may change a first type of order UI displayed on the URL to a second type of order UI.

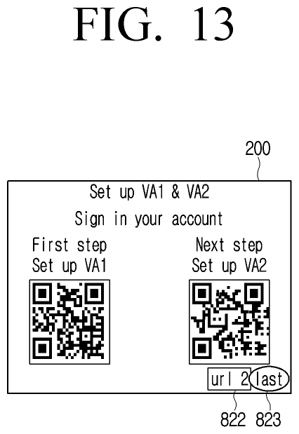

According to an embodiment, the processor 230, if a login process for the voice assistant 1 is completed, may change “2” displayed on the URL 2 822 to “last” 823 as shown in FIG. 13. Accordingly, the user may more easily recognize the login process for the lastly remaining voice assistant thanks to the currently proceeding login process.

Meanwhile, according to an embodiment, the electronic device 200 may be implemented as a foldable electronic device.

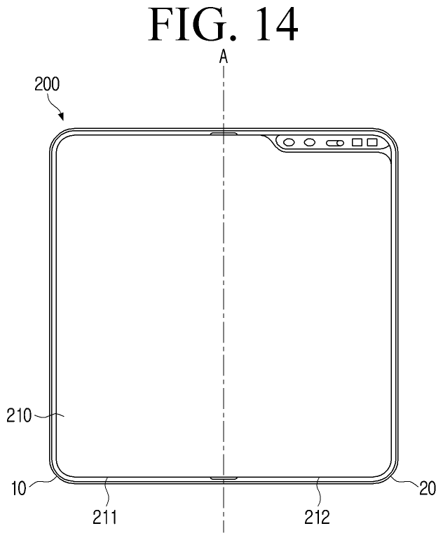

With reference to FIG. 14, the foldable electronic device 200 may include a pair of housings 10, 20 pivotably coupled through a hinge effector to be folded with respect to each other and a display 210 disposed in a space formed by the pair of housings 10, 20 (e.g. a flexible display or a foldable display).

The display 210 may include a firs area 211 of a first side (e.g. a left side) with reference to a folding axis A and a second area 212 of a second side (e.g. a right side) with reference to the folding axis A. The first area 211 may be positioned on a first housing 10 and the second area 212 may be positioned on a second housing 20.

In this case, the processor 230 may perform a plurality of login processes by using a multi screen (e.g. the first area 211 and the second are 212) of the display 210.

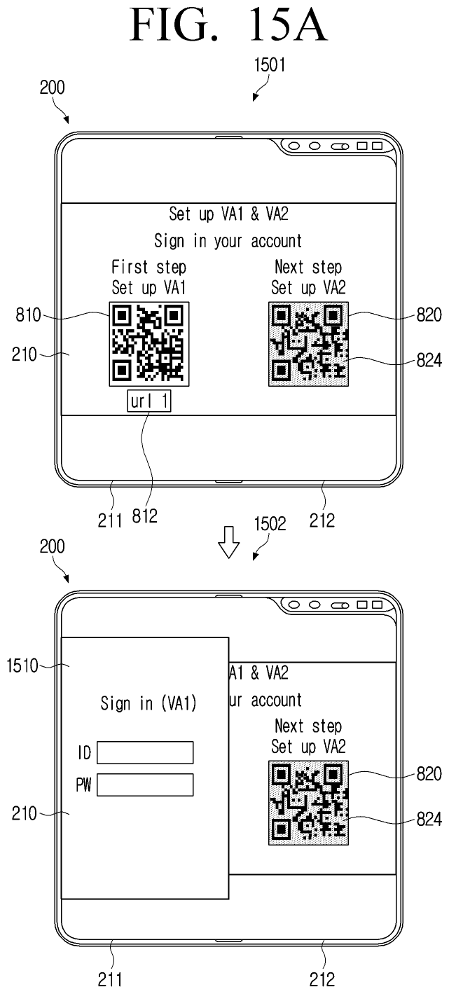

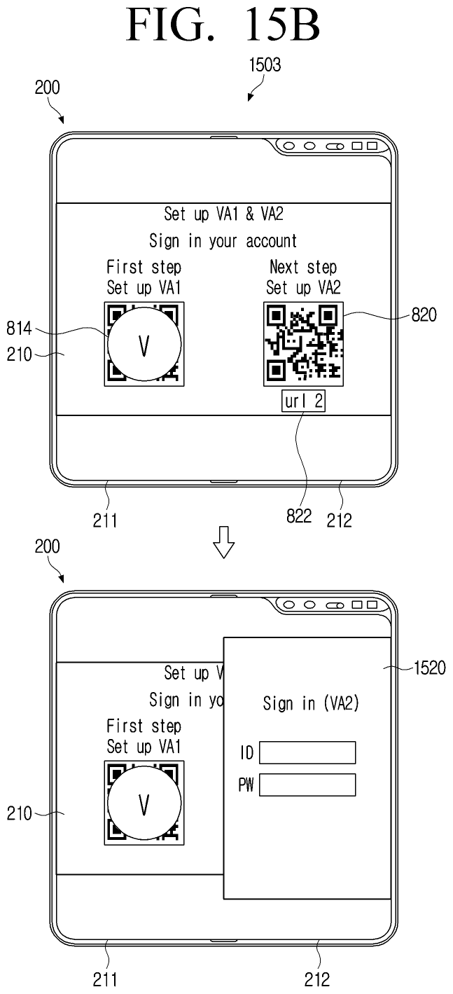

According to an embodiment, as shown in 1501 of FIG. 15A, the processor 230 may display the URL 1 812 in a pop-up form on an image including the QR codes 810, 820. Here, the URL 1 812 may be a URL obtained from the QR code 810 corresponding to the voice assistant 1 of which the onboarding order is the fastest. Also, as shown in 1501 of FIG. 15A, the processor 230 may deactivate the other QR codes, excluding the voice assistant 1, that is, the QR code 820 corresponding to the voice assistant 2.

Thereafter, the processor 230 may connect to the server 10 by using a URL obtained from the QR code 810 and display a login screen provided by the server 10 on the display 210. In this case, according to an embodiment, as shown in 1502 of FIG. 15A, the processor 230 may display the login screen 1510 on the first area 211 of the display 210.

Further, the processor 230 may log in the server 10 by using the login information inputted to the login screen 1510.

Then, the processor 230, if login is performed based on the user account corresponding to the voice assistant 1, may remove the URL 1 812 and display the URL 2 822 in a pop-up form on the image including the QR codes 810, 820 as shown in 1503 of FIG. 15B. Here, the URL 2 822 may be a URL obtained from the QR code 820 corresponding to the voice assistant 2 onboarded next to the voice assistant 1 among the plurality of voice assistants. Also, as shown in 1503 of FIG. 15B, the processor 230 may display a completion UI 814 on the QR code 810 corresponding to the voice assistant 1 and activate the deactivated QR code 820.

Thereafter, the processor 230 may connect to the server 20 by using a URL obtained from the QR code 820 and display a login screen provided by the server 20 on the display 210. In this case, according to an embodiment, as shown in 1504 of FIG. 15B, the processor 230 may display the login screen 1520 on the second area 212 of the display 210.

Further, the processor 230 may log in the server 20 by using the login information inputted to the login screen 1520.

As above, the electronic device 200 may provide the login screen through each area 210, 220 of the display 210 by using the multi screen and the login process proceeds.

Meanwhile, in the aforementioned examples, it is described that two voice assistants are onboarded to the display device 100 but it is merely an example, wherein two or more voice assistants may be onboarded to the display device 100. In this case, the display device and the electronic device 100, 200 may sequentially display various UIs related to the plurality of QR codes based on an order in which the plurality of voice assistants are onboarded to the display device 100.

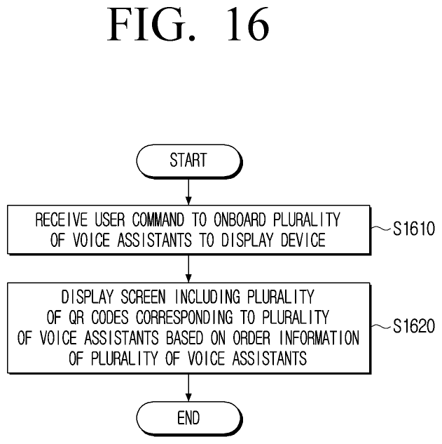

FIG. 16 is a flow chart illustrating a method of controlling a display device according to an embodiment.

In advance, the method includes receiving a user command for onboarding a plurality of voice assistants to a display device (S1610).

Further, the method includes displaying a screen including a plurality of QR codes corresponding to the plurality of voice assistants based on order information of the plurality of voice assistants (S1620).

Here, each of the plurality of QR codes includes a URL of a server at which login of a user account corresponding to a voice assistant is performed.

Also, the step S1620 includes, if capture completion information is received from an electronic device obtaining an image including the plurality of QR codes displayed on the display device, deactivating the other QR codes, excluding a first QR code corresponding to a first voice assistant of which an onboarding order is the fastest among the plurality of QR codes displayed on the display based on the order information, and if login is performed based on the user account corresponding to the first voice assistant, displaying a completion UI on the first QR code and activating a second QR code corresponding to a second voice assistant having an onboarding order next to the first voice assistant among the other deactivated QR codes based on the order information.

Further, the step S1620 includes displaying a plurality of order UIs on the plurality of QR codes based the order information.

Also, the step S1620 includes, if login is performed based on the user account corresponding to the first voice assistant, changing a first type of order UI displayed on a preset area within the second QR code to a second type of order UI. Here, the first type of order UI may include a number indicating an order in which the second voice assistant corresponding to the second QR code is onboarded, and the second type of order UI may include a character indicating an order in which the second voice assistant corresponding to the second QR code is onboarded.

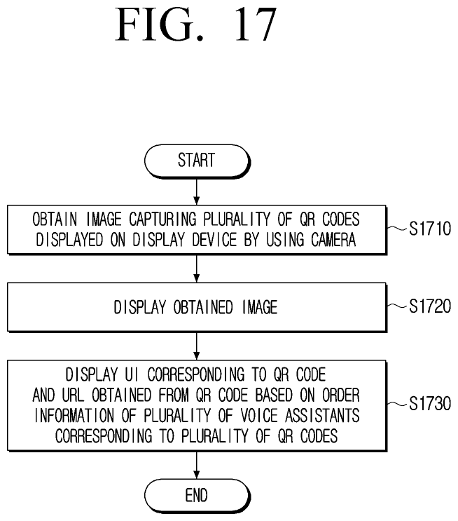

FIG. 17 is a flow chart illustrating a method of controlling an electronic device including a camera according to an embodiment.

In advance, the method includes obtaining an image capturing a plurality of QR codes displayed on a display device by using the camera (S1710).

Thereafter, the method induces displaying the obtained image (S1720).

Further, the method induces displaying a UI corresponding to a QR code and a URL obtained from the QR code based on order information of a plurality of voice assistants corresponding to the plurality of QR codes (S1730).

Here, each of a plurality of URLs is a URL of a server at which login of a user account corresponding to a voice assistant is performed.

Otherwise, the step S1730 includes displaying a plurality of order UIs indicating an order in which the plurality of voice assistants are onboarded to the display device on the plurality of QR codes based on the order information, displaying a URL obtained from a first QR code corresponding to a first voice assistant of which an onboarding order is the fastest among the plurality of voice assistants based on the order information, and if login is performed based on the user account corresponding to the first voice assistant, displaying a URL obtained from a second QR code corresponding to a second voice assistant having an onboarding order next to the first voice assistant based on the order information.

Further, the step S1730 includes focusing on and displaying the first QR code corresponding to the first voice assistant based on the order information, and if login is performed based on the user account corresponding to the first voice assistant, focusing on and displaying the second QR code corresponding to the second voice assistant based on the order information.

Otherwise, the step S1730 includes displaying a plurality of URLs and displaying the plurality of order UIs indicating the order in which the plurality of voice assistants are onboarded to the display device on the plurality of URLs based on the order information.

Meanwhile, according to an embodiment, a method according to examples of the disclosure may be provided to be included in a computer program product. The computer program product may be traded between a seller and a buyer as goods. The computer program product may be distributed in a form of the machine-readable storage medium (e.g. compact disc read only memory (CD-ROM)) or on-line distributed (e.g. downloaded or uploaded) via an application store (e.g. play store™) or directly between two user devices (e.g. smart phones). In the case of the on-line distribution, at least part of the computer program product (e.g. a downloadable app) may be stored at least temporarily or may be generated temporarily in the machine-readable storage medium such as memory of a server of a manufacturer, a server of an application store, or a relay server.

As aforementioned, each of the components (e.g. a module or a program) according to the various embodiments of the disclosure as above may be configured as a single item or a plurality of items, wherein partial subcomponents of the aforementioned relevant subcomponents may be omitted or another subcomponent may be further included in various embodiments. Mostly or additionally, some components (e.g. a module or a program) may be integrated into one item and may identically or similarly perform a function implemented by each of the relevant components before the integration.

According to various embodiments, operations performed by a module, a program, or another component may be executed sequentially, in parallel, repetitively, or heuristically, at least part of the operations may be executed in different orders or be omitted, or another operation may be added.

Meanwhile, the term “part” or “module” used in the disclosure may include a unit configured of hardware, software, or firmware and may be interchangeably used with the term, for example, logic, a logic block, a part, a circuit, or the like. The term “part” or “module” may be an integrally configured component or a minimum unit or its part performing one or more functions. For example, the module is configured as an application-specific integrated circuit (ASIC). Thus, each “module” herein may comprise circuitry.

Meanwhile, a non-transitory computer readable medium storing a program sequentially performing a control method according to the disclosure may be provided. The non-transitory readable medium does not mean a medium that stores data for a short time such as a resistor, a cache, memory, or the like but a machine readable medium that stores data semipermanently. Specifically, the aforementioned various applications or programs may be provided in a form stored in the non-transitory readable medium such as a CD, a DVD, a hard disk, a Blu-ray disk, a USB, a memory card, or ROM.

Also, the examples of the disclosure may be implemented as software including instructions stored in the machine-readable storage media, which can be read by the machine (e.g. a computer). The machine may refer to a device which calls instructions stored in the storage media and is operable according to the called instructions, wherein it may include an electronic device according to the disclosed embodiments.

If the instructions are executed by a processor, the processor may perform a function corresponding to the instructions directly or by using other components under control of the processor. The instructions may include a code generated or executed by a compiler or an interpreter.

As above, preferable examples of the present disclosure are shown and described. However, the disclosure is not limited to the aforementioned specific examples, and various modifications may be implemented by those skilled in the art without deviating from the gist of the disclosure claimed in the scope of claims, wherein these modifications should not be independently understood from the technical spirit or prospect of the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A display device comprising:
a display; and
one or more processors, comprising processing circuitry, individually and/or collectively configured to:
receive a user command for onboarding a plurality of voice assistants to the display device; and
control the display to display a screen including a plurality of QR codes corresponding to the plurality of voice assistants based on order information of the plurality of voice assistants,
wherein each of the plurality of QR codes includes:
a URL of a server at which login of a user account corresponding to a voice assistant is to be performed.

2. The display device of claim 1, further comprising:
a communication interface comprising circuitry,
wherein the one or more processors are individually and/or collectively configured to:
based on capture completion information received from an electronic device obtaining an image including the plurality of QR codes displayed on the display through the communication interface, deactivate the other QR codes, excluding a first QR code corresponding to a first voice assistant of which an onboarding order is the fastest among the plurality of QR codes displayed on the display based on the order information; and
based on login being performed based on the user account corresponding to the first voice assistant, display a completion UI on the first QR code and activate a second QR code corresponding to a second voice assistant having an onboarding order next to the first voice assistant among the other deactivated QR codes based on the order information.

3. The display device of claim 2, wherein the one or more processors are individually and/or collectively configured to:
control to display a plurality of order UIs on the plurality of QR codes based on the order information.

4. The display device of claim 3, wherein the one or more processors are individually and/or collectively configured to:
based on login being performed based on the user account corresponding to the first voice assistant, change a first type of order UI displayed on a preset area within the second QR code to a second type of order UI,
wherein the first type of order UI includes a number indicating an order in which the second voice assistant corresponding to the second QR code is onboarded, and wherein the second type of order UI includes a character indicating the order in which the second voice assistant corresponding to the second QR code is onboarded.

5. An electronic device comprising:
a display;
a camera; and
one or more processors, comprising processing circuitry, individually and/or collectively configured to:
obtain an image capturing a plurality of QR codes displayed on a display device using the camera;
display the obtained image on the display; and
control the display to display a UI corresponding to a QR code and a URL obtained from the QR code based on order information of a plurality of voice assistants corresponding to the plurality of QR codes,
wherein each of a plurality of URLs is:
a URL of a server at which login of a user account corresponding to a voice assistant is performed.

6. The electronic device of claim 5, wherein the one or more processors are individually and/or collectively configured to:
display a plurality of order UIs indicating an order in which the plurality of voice assistants are onboarded to the display device on the plurality of QR codes based on the order information;
display a URL obtained from a first QR code corresponding to a first voice assistant of which an onboarding order is the fastest among the plurality of voice assistants based on the order information; and
based on login being performed based on the user account corresponding to the first voice assistant, display a URL obtained from a second QR code corresponding to a second voice assistant having an onboarding order next to the first voice assistant based on the order information.

7. The electronic device of claim 6, wherein the one or more processors are configured to:
focus on and display the first QR code corresponding to the first voice assistant based on the order information; and
based on login being performed based on the user account corresponding to the first voice assistant, focus on and display the second QR code corresponding to the second voice assistant based on the order information.

8. The electronic device of claim 6, wherein the one or more processors are configured to:
display a plurality of URLs and display the plurality of order UIs indicating the order in which the plurality of voice assistants are onboarded to the display device on the plurality of URLs based on the order information.

9. A method of controlling a display device, the method comprising:
receiving a user command for onboarding a plurality of voice assistants to the display device; and
displaying a screen including a plurality of QR codes corresponding to the plurality of voice assistants based on order information of the plurality of voice assistants,
wherein each of the plurality of QR codes includes:
a URL of a server at which login of a user account corresponding to a voice assistant is performed.

10. The method of claim 9, wherein the displaying includes:
based on capture completion information being received from an electronic device obtaining an image including the plurality of QR codes displayed on the display device, deactivating the other QR codes, excluding a first QR code corresponding to a first voice assistant of which an onboarding order is the fastest among the plurality of QR codes displayed on the display based on the order information; and
based on login being performed based on the user account corresponding to the first voice assistant, displaying a completion UI on the first QR code and activating a second QR code corresponding to a second voice assistant having an onboarding order next to the first voice assistant among the other deactivated QR codes based on the order information.

11. The method of claim 10, wherein the displaying includes:
displaying a plurality of order UIs on the plurality of QR codes based on the order information.

12. The method of claim 11, wherein the displaying includes:
based on login being performed based on the user account corresponding to the first voice assistant, changing a first type of order UI displayed on a preset area within the second QR code to a second type of order UI,
wherein the first type of order UI includes a number indicating an order in which the second voice assistant corresponding to the second QR code is onboarded, and
wherein the second type of order UI includes a character indicating the order in which the second voice assistant corresponding to the second QR code is onboarded.
